(19) United States
(12) Patent Application Publication
(10) Pub. No.: US 2008/0240443 A1
(43) Pub. Date: Oct. 2, 2008

(54) METHOD AND APPARATUS FOR SECURELY PROCESSING SECRET DATA

(75) Inventors: Camille VUILLAUME, Tokyo (JP); Katsuyuki Okeya, Sagamihara (JP); Masayuki Yoshino, Yokohama (JP)

Correspondence Address: FOLEY AND LARDNER LLP;SUITE 500, 3000 K STREET NW, WASHINGTON, DC, 20007, US

(73) Assignee: HITACHI, LTD

(21) Appl. No.: 12/022,650

(22) Filed: Jan. 30, 2008

(30) Foreign Application Priority Data
Mar. 29, 2007 (JP) 2007-088812

(51) Int. Cl. H04L 9/06

(52) U.S. Cl. 380/277

(57) ABSTRACT

Using the same secret key for different secret operations in the frame of public key cryptosystems raises security problems because attackers can gain statistical information about the secret key. Indeed, when randomization techniques are used, the same secret key is randomized differently for every new operation, and since information leakage sums up, eventually, the attacker is able to recover the secret key.

A system and method for using the same secret key of a public key cryptosystem several times comprising a recoding method which can generate several distinct representations for the secret key, where one representation is chosen as recoded secret according to a selection data. In addition, the pair consisting of the secret key and selection data is uniquely defined, resulting in the same recoded secret for every new encryption operation. As a consequence, information leakage does not sum up and the secret key can be securely re-used.

### INCORPORATION BY REFERENCE

This application claims priority based on a Japanese patent application, No. 2007-088812 filed on Mar. 29, 2007, the entire contents of which are incorporated herein by reference.

### BACKGROUND OF THE INVENTION

The present invention relates to a method and apparatus for securely processing secret data in the field of security. More precisely, it relates to a secure implementation of public key cryptosystems on a computer system such as a smartcard, mobile phone, personal computer, workstation, server, or the like.

Public key cryptosystems have become essential for banking applications, electronic commerce and more generally for security in the digital world. Thanks to public key cryptosystems, it is possible to securely decide upon a shared secret value through insecure channels. Public key cryptosystems also allow one party to encrypt data for a second party, without prior exchange of any shared secret information. And finally, digital signatures can be generated thanks to public key cryptosystems.

Even though they are secure from a theoretical point of view, cryptosystems can be broken practically if they are not implemented carefully. In particular, using side channel information such as timings or power consumption, attackers can often reveal secret information on weak implementations. The idea of side channel attacks is to observe a physical parameter of the cryptosystem, for instance the power consumption of the device, and from this physical parameter, guess the secret information. This approach works for two reasons. First, there is often a correlation between the secret and the behavior of the device implementing the cryptographic algorithm. Second, side-channel information is also correlated with the behavior of the device: for instance, power consumption depends on the operations that are executed.

In addition to the type of physical information, such as timings, power consumption or electro-magnetic radiations, there are several methodologies for side channel attacks. In the case of power consumption analysis attacks, one can distinguish simple power analysis, or SPA, where the attacker analyzes one single power consumption trace directly and tries to identify some patterns, and differential power analysis, or DPA, where the attacker uses a statistical tool to analyze several power traces.

In some countermeasures against side channel attacks, the representation of secret data is modified in order to remove correlation between side channel information and secret data. For instance, it is common to introduce a fixed pattern in the representation of the secret: the operations that depend on the secret will be organized following the same pattern, preventing SPA-type leakages. Another approach is to randomly select representations among several candidates. Similarly, the operations that depend on the secret will be randomly re-organized, preventing SPA and DPA-type leakages.

The SPA-resistant fractional window method described in patent JP2005055488 (Patent 1) belongs to the family of randomized side channel countermeasures for elliptic curves. It randomizes the representation of the secret each time the cryptographic routine is called. The invention disclosed in patent WO2004055756 (Patent 2) describes a method for generating a random sequence of bits and using this sequence of bits to randomly select storage areas for cryptographic computations, but does not change the representation of the secret.

[Patent Document 1] Japanese Patent Laying-Open No. 2005-055488 (2005), Okeya Katsuyuki, Takagi Tsuyoshi: “Scalar multiple calculating method in elliptic curve cryptosystem, device and program for the same”, Hitachi Ltd;

[Patent Document 2] WO2004/055756, Takenaka Masahiko, Izu Tetsuya, Itoh Kouichi, Torii Naoya: “Tamper-resistant elliptical curve encryption using secret key”. Fujitsu, Ltd.; and

[Non-Patent Document 1] Alfred J. Menezes, Paul C. van, Oorschot, Scott A. Vanstone: “Handbook of applied cryptography”, CRC press, ISBN: 0-8493-8523-7.

### BRIEF SUMMARY OF THE INVENTION

Implementations of public-key cryptosystems based for instance on Patent 1 or 2 often include countermeasures to ensure tamper-resistance. However, prior art techniques suffer from the following problem:

With prior art techniques such as Patent 1, secure representations do not allow to re-use the same secret key. On the one hand, in the case where a secret key is used for one single cryptographic operation, randomized techniques such as Patent 1 are secure because side-channel attacks fail to retrieve sufficient secret information. On the other hand, in the case where the same secret key is used several times, attackers can gather statistical information about the secret, because each new execution of the cryptographic operation provides attackers with fresh new information.

Accordingly, besides the objects and advantages of the invention described in the above patent, several objects and advantages of the present invention are:

1. To remove correlation between secret data and side-channel information,

2. To allow multiple and secure uses of the same secret data for decrypting a message, exchanging keys or generating a digital signatures.

According to the present invention, there is used a randomized representation to remove correlation between secret data and side-channel information. With the techniques used in prior art, attackers can gather statistical information if the same secret data is used in conjunction with a randomized countermeasure, because the secret key provides attackers with new information at each execution of a cryptographic routine. Indeed, in the prior art, the source of randomness comes from a pseudo-random number generator initialized with a random seed, or from a hardware random number generator. In the present invention, the source of randomness uniquely comes from the secret key, and all random choices are determined by the value of the secret key. More precisely, according to the present invention is generated a sequence of bits which is uniquely and deterministically determined from the secret key, using a non-invertible hash function or a block cipher for instance. Then, it computes several concurrent representations for the secret key and chooses one of them according to generated sequence of bits. Finally, cryptographic operations are performed according to the selected representation.

In the frame of the present invention, the randomized representation of the secret data is chosen according to a uniquely determined selection data. Therefore, even when the message is changed, as long as the secret remains the same, the cryptographic algorithm, which can be a key exchange, data encryption or a digital signature, will output the same piece of side channel information. Therefore, attackers cannot take advantage of multiple calls to the cryptographic algorithm. Or equivalently, the same secret can be safely re-used with the randomized representation-based countermeasure, according to the present invention.

These and other benefits are described throughout the present specification. A further understanding of the nature and advantages of the invention may be realized by reference to the remaining portions of the specification and the attached drawings.

### BRIEF DESCRIPTION OF THE DRAWINGS

Those and other objects, features and advantages of the present invention will become more readily apparent from the following detailed description when taken in conjunction with the accompanying drawings wherein:

FIG. 1 is the block diagram for showing general settings of the entire system, according to the present invention;

FIG. 2 is the hardware diagram for showing computer system and network, according to the present invention;

FIG. 3 is the time diagram and data flow for showing RSA (Embodiment 1);

FIG. 4 is the block diagram for showing arithmetic modules for RSA (Embodiment 1);

FIG. 5 is the block diagram for showing selection data generation for RSA (Embodiment 1);

FIG. 6 is the block diagram for showing system parameters generation for RSA (Embodiment 1);

FIG. 7 is the block diagram for showing recoding for RSA (Embodiment 1);

FIG. 8 is the block diagram for showing RSA Message encryption (Embodiment 1);

FIG. 9 is the time diagram and data flow for ECC;

FIG. 10 is the block diagram for showing arithmetic modules for ECC (Embodiment 2);

FIG. 11 is the block diagram for showing system parameters generation for ECC (Embodiment 2); and

FIG. 12 is the block diagram for showing ECC Message encryption (Embodiment 2).

### DESCRIPTION OF THE EMBODIMENTS

Hereinafter, embodiments according to the present invention will be fully explained by referring to the attached drawings.

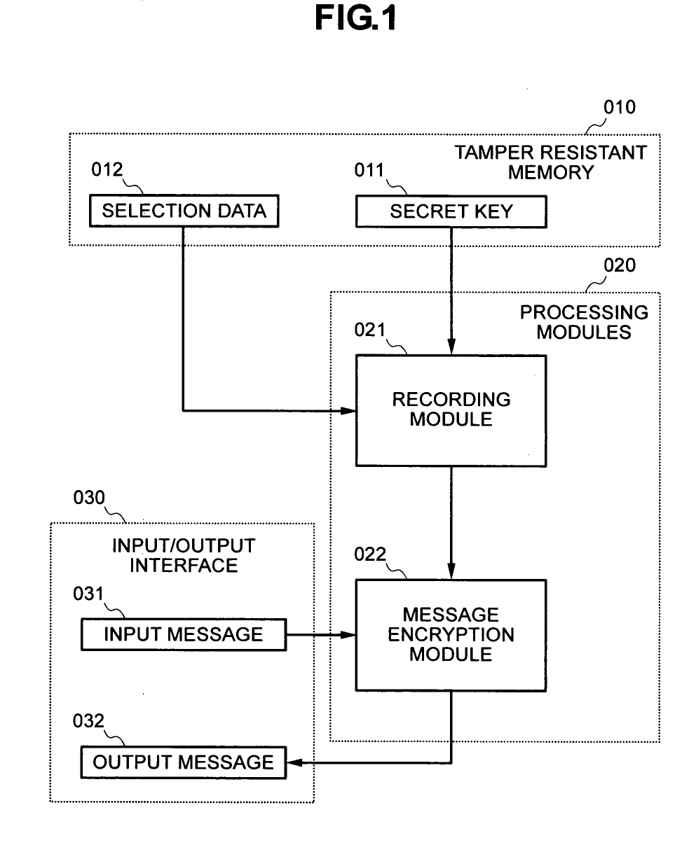

### <General Settings; FIG. 1>

The recoding module 021 is able to potentially output several distinct recodings of the secret key 011; here, we call a recoding of the secret key a representation of this key by a sequence of digits. For example, the binary, decimal or hexadecimal representations are possible recodings. However, a more judicious choice would be a secure representation as in Patent 1. Indeed, the representations introduced in Patent 1 have the property to remove the correlation between side channel information leakage and the secret key.

In addition, the recoding module selects one of the possible recodings according to a selection data 012, where one secret key 011 is uniquely associated with one selection data 012. For instance, one can derive the selection data from the secret key by processing it with a non-invertible hash function. Alternatively, one can generate the selection data in the same time as the key, and store the pair consisting of the key and the selection data in tamper-resistant memory 011 with restricted read access and forbidden write access. In both cases, the pair secret key-selection data is uniquely defined.

### Embodiment 1

### Secure Multiple Use of a Secret Key for RSA

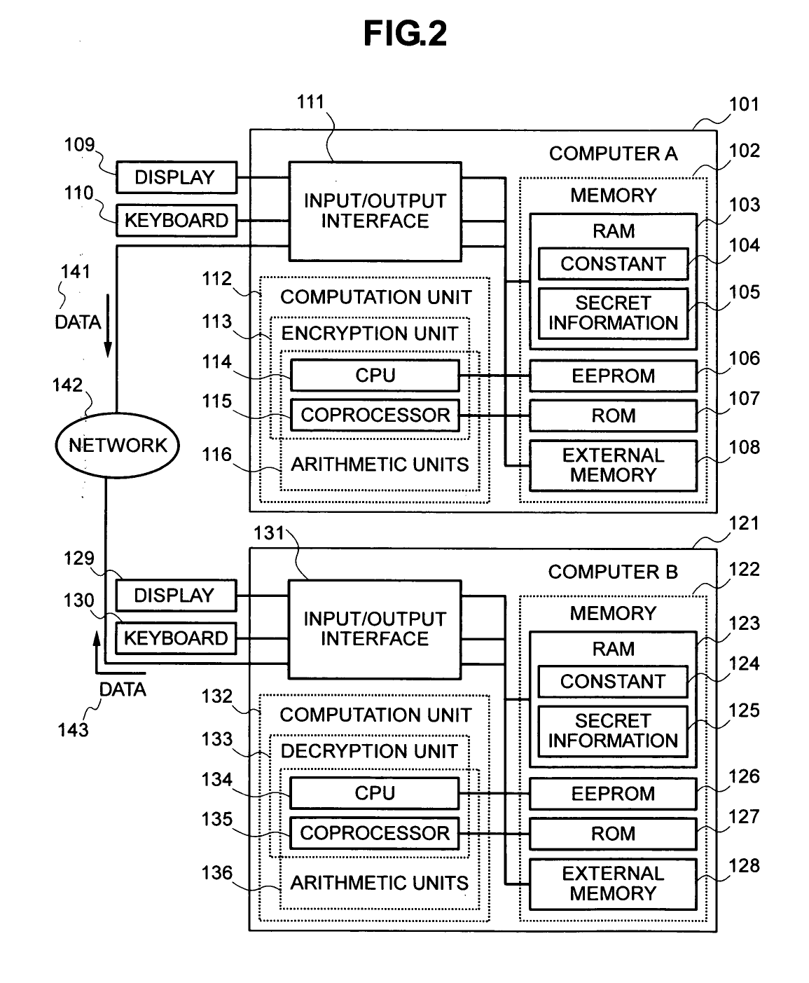

### *Computer System and Network, FIG. 2*

A computer refers to a workstation, a server, a bank terminal, a smart card, a mobile phone or any electronic device with data storage, communication and processing units. A computer can have several computation units 112: at least one CPU 114, and in some cases a coprocessor 115. The coprocessor is useful for computing a certain type of operations, and in particular modular operations in the case of public key cryptosystems. For accelerating the computation of RSA or elliptic curves, which are the most common public key cryptosystems, the coprocessor implements modular implementation, which can be computed orders of magnitude faster than with the CPU.

Computers have three types of memory: volatile memory, RAM 103, whose content is lost when the power is turned off, writable non-volatile memory, EEPROM 107, which is slower than RAM, has read and write access, but can store data when the power supply is off, and read-only non volatile memory, ROM 108, whose content does not get lost when the power supply is turned off, but which only has read access. The ROM stores programs, whereas the EEPROM can store programs, patches and long-term data such as public and private keys. Since the RAM is volatile, it can only store short-term and temporary data.

Computers also typically have an input/output interface 111, for sending and receiving data from peripherals such as a display 109 or a keyboard 110, but also to the network 142.

One first possible scenario of our patent is as follows: a computer 101 receives a message from the network 142 or possibly from a human user using the keyboard 110 via the input/output interface 111. Next, computer 101 generates a digital signature of the message. A popular way of generating such digital signature is to use public key cryptosystems; such cryptosystems have the particularity that they have two different keys, one secret key held by the signer (computer 101) and one public key accessible to the verifier (computer 121). In addition, one can recover data encrypted with the secret key by encrypting it again with the public key. Back in our scenario, computer 101 encrypts the message with a secret key stored in non-volatile memory 106 to obtain a digital signature. The encryption process is realized by the arithmetic units 116 and especially the coprocessor 115 which can perform special cryptographic operations more efficiently than the general-purpose CPU 114.

Finally, computer 101 sends both of the message and its signature to a second computer 121 via the network 142, and computer 121 encrypts the signature using computer 101's public key. By property of the public key cryptosystem, if the signature was really generated by computer 101, computer 121 should recover the initial message in the encryption process. Therefore, by comparing the received message to the signature encrypted with the public key, computer 121 can confirm that message M was duly written and signed by computer 101.

A second possible scenario of our patent is as follows: a computer 101 receives an encrypted input message from a second computer 121 via the network and the input/output interface 111, and the input message is encrypted with a public key cryptosystem, or more precisely, is encrypted by computer 121 with computer 101's public key. Next, computer 101 decrypts the input message using his secret key, and recovers the original message, using arithmetic units 116 and especially the coprocessor 115. Finally, the decrypted message can be forwarded to the display 109 via the input/output interface, and be examined by a human user.

A third scenario for our patent is as follows: two computers 101 and 121 exchange a common session key through the network 142 using a public key cryptosystem. Firstly, computer 101 and 121 agree on a common publicly known message. Then, computer 101 encrypts the common message with his secret key, and sends the encrypted message to computer 121; computer 121 does the same. Next, computer 101 receives the message encrypted by computer 121, and encrypts it once again with his secret key: computer 121 does the same. Now, computer 101 and 121 share a common session key known by them only, namely the initial message encrypted with both of their secret keys. After that, computer 101 and 121 can exchange messages encrypted with their common session key through the network 141.

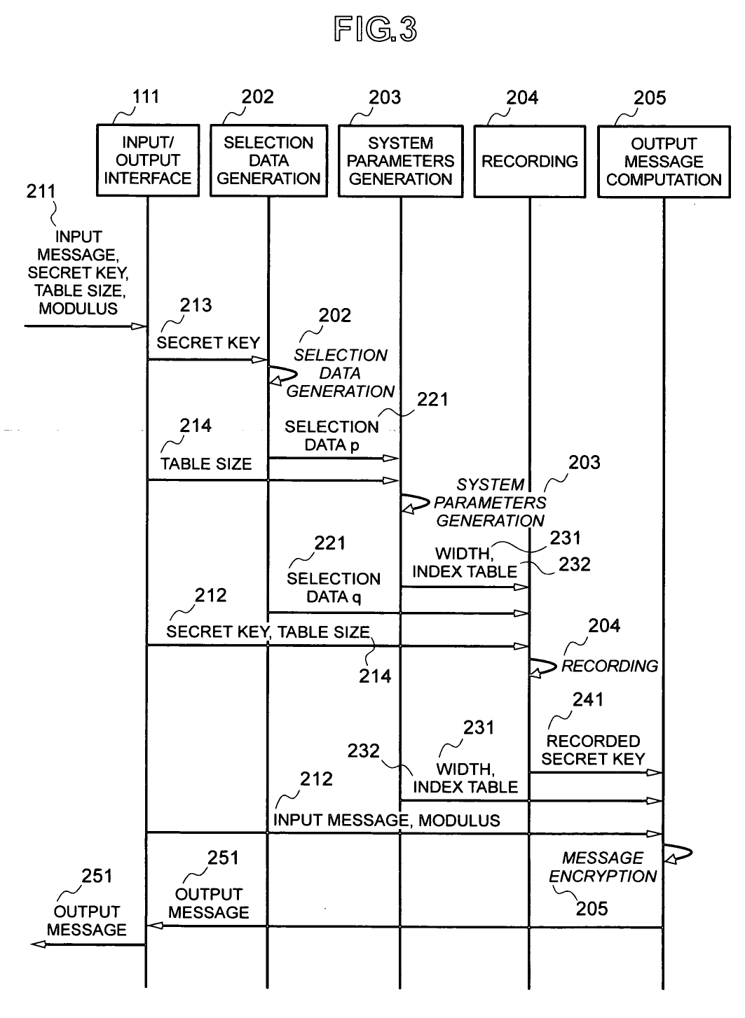

### *Time Diagram and Data Flow, FIG. 3*

FIG. 3 is the time diagram of a cryptographic computation executed by computer 101. This cryptographic operation processes an input message according to a secret key and a table size in order to compute an output message, where the output message is forwarded to the input/output interface 111 for means of digital signature, public key decryption or key exchange.

The input 211 of the secret cryptographic computation includes the input message 216, the secret key 212 and the table size 214. The input message can be generated by a peripheral such as a keyboard 110, or can be a message received from the network 142 via the input/output interface 111. Alternatively, the message can be data stored in memory 102. The secret key is stored in non-volatile memory, that is, EEPROM 106 or ROM 107. Finally, the table size can be selected thanks to a peripheral such as the keyboard 110. Alternatively, it can be dynamically chosen by the CPU 114 according to the available RAM 103, or even retrieved from non-volatile memory (ROM or EEPROM), in which case it is a fixed system parameter.

First of all, from the secret key 212, the selection data p 221 and q 222 are generated in module 202. The generation of the selection data involves computation units, including the CPU 114 and possibly the coprocessor 115. In some cases, the selection data can be stored in non-volatile memory 106 or 107 from previous sessions or even card initialization. For future uses, the selection data is stored in RAM 103 in order to allow faster accesses.

Next, using the selection data and the table size, system parameters are chosen in module 203, including the width w 231 and the index table B[1], . . . , B[2^{w}] 232. This module requires both of the selection data 221 p and the table size 214, computes system parameters with the CPU 114, and stores them in RAM 103. In some cases, the system parameters can be retrieved from non-volatile memory from previous sessions or initialization stage, but is transferred to RAM 103 to allow faster accesses.

After that, the representation of the secret key 212 is changed in the recoding module 204, using the table size 214, width 231, index table 232, and selection data q 222, which are stored in RAM at this point. The recoding module scans the secret key, and computes a new representation with the CPU 114 for the secret key according to the table size, selection data and system parameters. Finally, the recoded secret key is stored in RAM 103. Like previously, it is also possible to retrieve the recoded secret key from previous sessions or card initialization.

Finally, from the input message 212, width 231, index table 232 and the recoded secret key 241, the output message 251 is computed with the CPU 114 and the coprocessor 115 in the message encryption module 205. The output message 251 is forwarded to the input/output interface 111, and sent to the network 142.

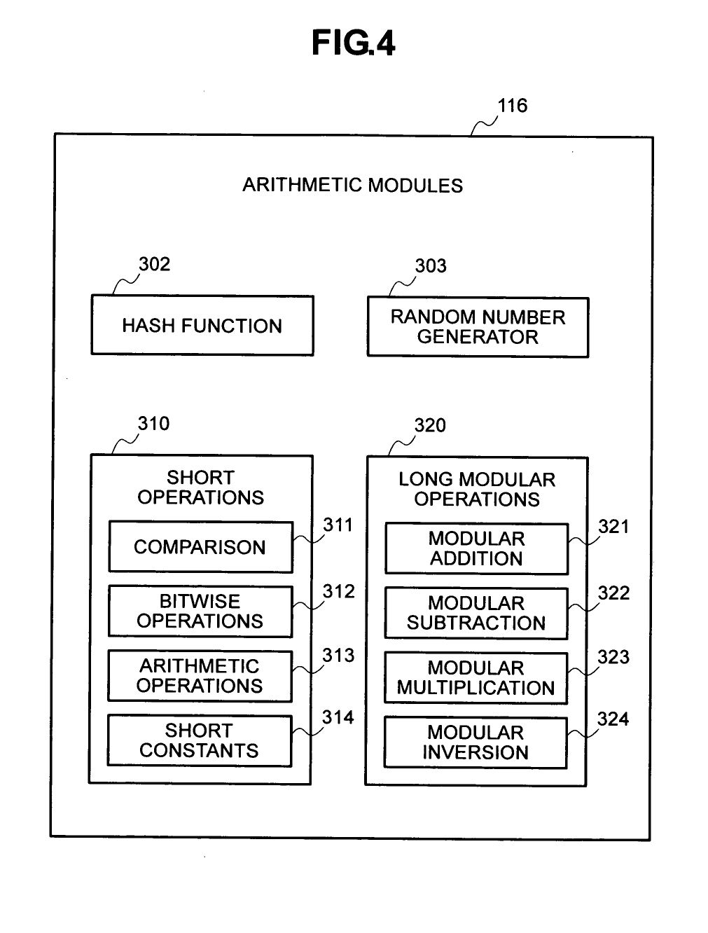

### *Arithmetic Modules, FIG. 4*

The arithmetic modules can be classified into four categories: short operation modules 301, long modular operation modules, random number generator 303 and hash function 302, and modular multiplication modules.

Basic arithmetic modules 301 include short operation modules 310 and long modular operation modules 320. Short operations refer to calculation with small operands, that is, size up to 32 bits. In our preferred embodiment, these instructions, including the comparison module 311, bit manipulation module 312 and arithmetic module 313 are supported in the instruction set of the CPU 114.

The comparison module 311 is able to compare two pieces of data, which can be variables from RAM 103 or EEPROM 106, or constants from ROM 107 or EEPROM 106 such as 0 or 1. The scope of the comparison can be equality =, difference <>, strictly smaller <, strictly larger >, smaller or equal <=, larger or equal >=. Bit manipulation operations 312 manipulate the bits of their operations, which can be variables or constants. They include the following operations: bitwise XOR, bitwise AND, bitwise OR, bitwise negation NOT, left shift <<, right shift >>, and cyclic shift. Also, the CPU 114 instruction set includes arithmetic operations 313, such as addition +, subtraction −, multiplication * and division / of short variables or constants, 32 bits in our preferred embodiment. Also, increment x=x+1 and decrement x=x−1 are supported by the CPU 114. Finally, some short constants 314 such as 0, 1 or 0x6ed9eba1 are available in ROM 107 or EEPROM 106. Here, the notation 0x . . . refers to hexadecimal notation.

Long modular operation modules 320 manipulate longer operands: 1024 bits for example in the case of RSA. In our preferred embodiment, the modular multiplication module 323 is implemented in the coprocessor 115, which computes A*B modulo N for any A, B and N. Since modular addition 321 and subtraction 322 are not costly compared to multiplications, they are implemented as a program stored in ROM 107 and executed by the CPU 114. Finally the modular inversion A⁻¹ mod P=A^{P-2} mod P for P prime integer is implemented as a program executed by the CPU 114, with the support of the coprocessor 115 for modular multiplications in the exponentiation A^{P-2} mod P.

The role of long modular multiplications is very important for digital signatures, and in particular for the popular public key cryptosystem RSA. More precisely, RSA signatures are generated and verified in the following manner. An input message M is encoded as an integer, for instance by interpreting the bit sequence of the message stored in memory as an integer. In addition, a key pair is generated and stored in non-volatile memory, where the key pair consists of a secret integer d, henceforth called secret key, two secret prime integers P and Q, and one public exponent e and one public modulus N, satisfying the equations:

N=P*Q

and

e*d=1 mod (P−1)*(Q−1)

Next, the signature of message M is the result of the exponentiation C=M^{d} mod N, using the secret key calculated with modular multiplications such as A*B mod N. Upon receiving a message M and its signature C, the authenticity of the message can be confirmed by calculating M′=C^{e} mod N: the message is authenticated in the case where M′=M.

The random number generator 303, which takes a seed of at most 512 bits as input and returns random data of arbitrary length, makes use of the hash function 302 as well as short operation modules, including comparisons 311, bitwise operations 312, arithmetic operations 313 and short constants 314. In our preferred embodiment, the random number generator is based on the DSA random number generator standardized by FIPS and based on the hash function SHA-1 302; both are described in non-patent literature 1. The random number generator 303 and the hash function 302 are implemented as programs stored in ROM 107, executed by the CPU 114. However, the scope of our invention is not limited to a particular generation method of the selection data. Other deterministic methods could be used; for instance, by purely using a hash function or a block cipher, or a different random number generator.

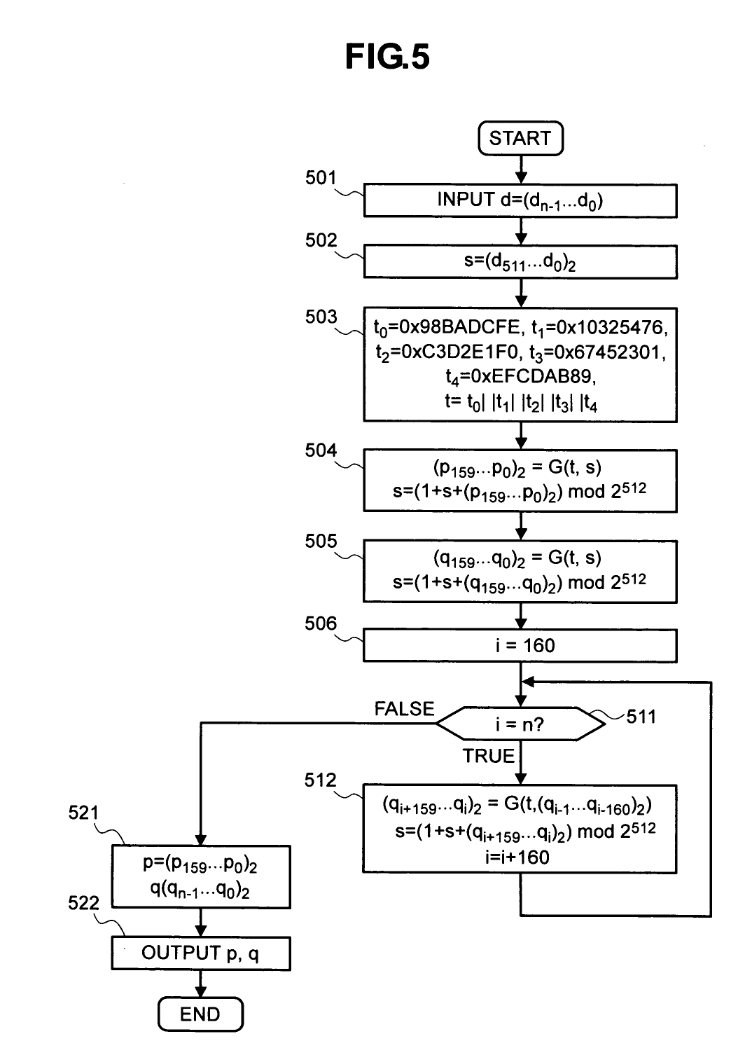

### *Selection Data Generation Module, FIG. 5*

The target of the selection data generation module is to compute two pieces of data, p and q, where p has 160 bits and q has the same bitlength as the secret key d. In this embodiment of our invention, the selection data is exclusively generated by a random number generator, namely the DSA random number generator standardized by FIPS and described in non-patent literature 1. However, there is one major difference compared to typical uses of random number generators: the seed s is not a random number, but in fact derived from the secret key d. Thus, the same secret key always produces the same selection data, in a way that even when the selection data is known by an attacker, it is impossible to recover the secret key.

More precisely, the seed s is computed in step 502 by extracting the first 512 least significant bits of the secret key d. Next, the 160-bit quantity t is read from non-volatile memory, for instance EEPROM 106. In our preferred embodiment, t is defined as t=t₀∥t₁∥t₂∥t₃∥t₄, where the 32-bit quantities t₀, . . . , t₄ are concatenated. In this embodiment, we define t₀=0x98BADCFE, t₁=0x10325476, t₂=0xC3D2E1F0, t₃=0x67452301, t₄=0xEFCDAB89, but in alternative embodiments, arbitrary values can be used for t. After that, in step 504, p is computed as G(t,s) using the one-way function G based on the hash-function SHA-1, standardized by FIPS and described in non-patent literature 1: t is set as the initial vector of SHA-1, and s is the input message processed by SHA-1. SHA-1 can be implemented by a program in ROM 107 and executed by the CPU 114, or alternatively, as a circuitry, part of the coprocessor 115. After that, the seed s is updated as s=(1+s+p) mod 2⁵¹² in step 504. In other words, the addition 1+s+p is computed, either by the CPU 114 or by the coprocessor in the case where it supports long integer addition, and the first 512 least significant bits are extracted from the result.

The same operations are repeated in step 505 to get the first 160 bits of the second piece of selection data (q₁₆₀ . . . q₀)₂. Next, in steps 511 and 512, the same operations are iterated in order to get more than n bits of selection data q. Finally, the first n least significant bits of q are extracted in step 521, and p and q are stored in RAM for future use.

Note that the scope of our patent is neither limited to the use of a particular one-way function G, nor to a particular implementation of the one-way function. In alternative embodiments, a different one-way function G could be used, based on a different hash function, RIPEMD-160 for example, or even based on a block cipher such as DES, triple DES or AES. In addition, the one-way function can be equally implemented as a program executed by the CPU 114 or as a circuitry, or any other implementation. Finally, instead of a random number generator, one could use a different approach to derive the selection data from the secret key, that is, not based on a random number generator, but a hash function or a block cipher for instance.

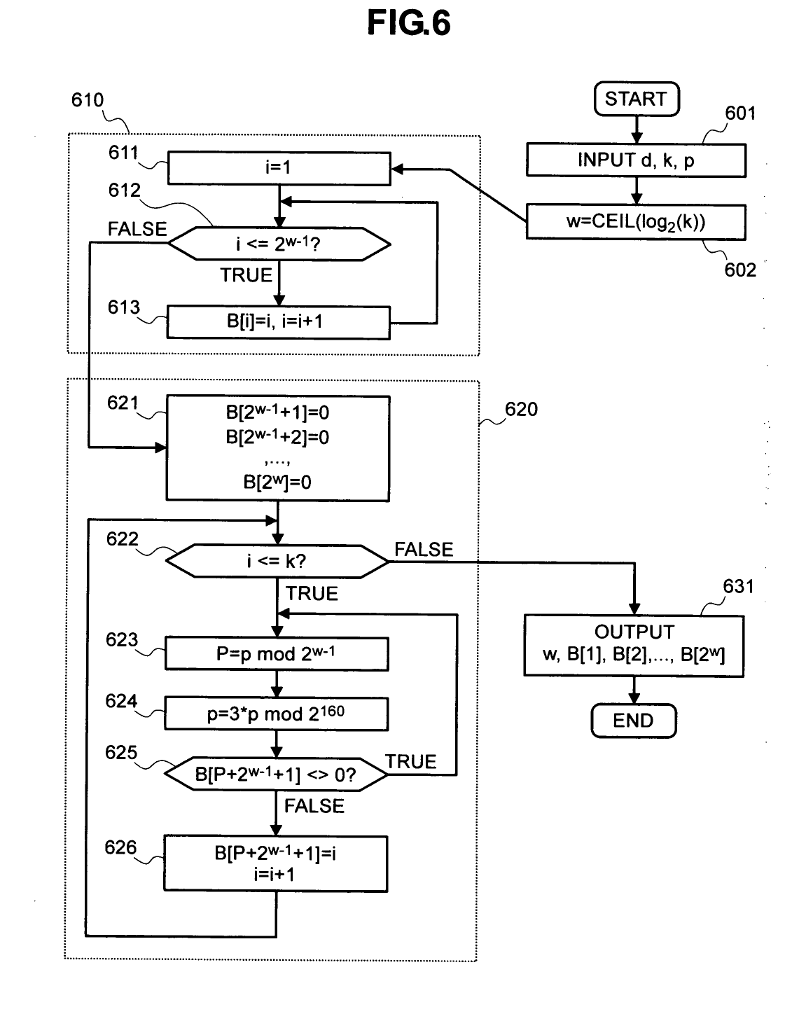

### *System Parameters Generation Module, FIG. 6*

From the secret key 213, the table size 214 and the selection data p, the system parameters generation module computes the upper width w and the index table B[1], B[2], . . . , B[2^{w}]. There are two stages in this module: the lower index table generation 610 which calculates B[1], . . . , B[2^{w-1}], and the upper index table generation 620, which calculates B[2^{w-1}+1], . . . , B[2^{w}]. The selection data p is used in module 620 in order to randomly select indices; for that purpose, random indices must be extracted from p, and then p is updated to a new value.

First, the upper width w is computed in step 602 as:

w=CEIL(log₂(k))

Where log₂ refers to the base 2 logarithm function and CEIL(log₂(k)) is the closest integer greater than log₂(k). In our embodiment, the possible values of the width w are stored in a lookup table in EEPROM 106 or ROM 107 for several small values of the table size k. Alternatively, this step can be implemented as a program stored in EEPROM 106 or ROM 107, and executed by the CPU 114, or implemented as a circuitry in the coprocessor 115.

After that, the index table B[1], B[2], . . . , B[2^{w}] is computed. Each entry of the table B[i] is an integer. More precisely, for 1<=i<=2^{w-1}, B[i] is always non-zero, and for 2^{w-1}+1<=i<=2^{w}, B[i] can be non-zero or zero. In total, there are exactly k non-zero entries in the index table, where k is the table size: 2^{w-1} entries in the lower half of the index table, and k−2^{w-1} entries which are randomly chosen in the upper half of the index table.

In steps 611, 612 and 613, the lower half of the index table is initialized as:

B[1]=1, B[2]=2, . . . , B[2^{w-1}]=2^{w-1}.

These steps are simple memory assignments: the integers B[1] to B[2^{w-1}] are stored in RAM 103. In step 621, the upper half part of the index table is initialized with zeros. At this point, 2^{w-1} non-zero entries are available in the index table, and k−2^{w-1} non-zero entries are still missing, and will be randomly chosen in the upper half index table as follows, in steps 622, 623, 624, 625 and 626.

In step 623, the w−1-bit value P is extracted as P=p mod 2^{w-1}. In practice, the CPU 114 extracts the w−1 lower bits of the 160-bit data p to compute P. After that, in step 624, p is updated as p=3*p mod 2¹⁶⁰ using the coprocessor 115. Then, a random index 2^{w-1}+1<=P+2^{w-1}+1<=2^{w} is obtained for the upper half of the index table. If B[P+2^{w-1}+1]<>0, the index has already been selected as non-zero entry in the past, and steps 623 and 624 are repeated until a new value is obtained for P. After such a new index is extracted from the selection data, B[P+2^{w-1}+1] is updated with the index value i in step 626 and i is incremented. Steps 622 through 626 are iterated until the index table contains exactly k non-zero entries.

Finally, the upper width w and the index table B[1], B[2] until B[2^{w}] are stored in RAM for future use. Note that the scope of our patent is not limited to a particular method to extract random indices from the selection data p in step 623 or to update p in step 624, and in alternative embodiments, the index table B could be constructed in a different fashion. One possibility could be to update p with p/2^{w-1} or with SHA-1(p).

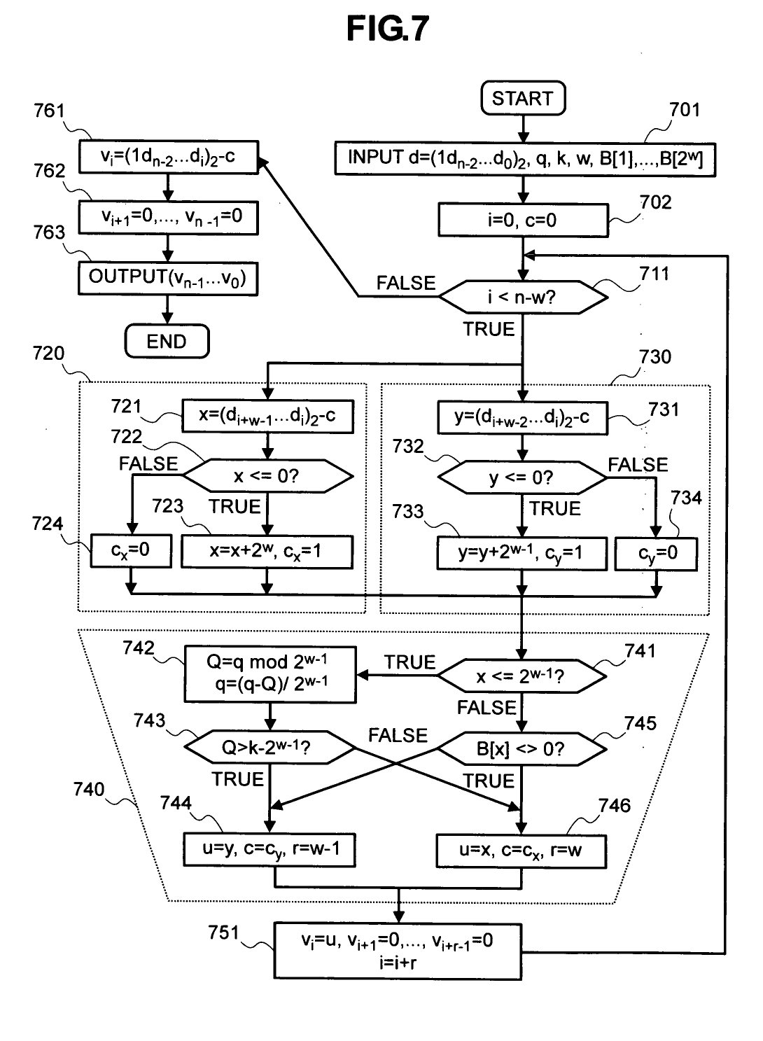

### *Recoding Module, FIG. 7*

The recoding module takes the n-bit secret key d 213, the selection data q 221 and the system parameters w, B[1], B[2], . . . , B[2^{w}] as input in step 701, and outputs the recoded secret (vₙ₋₁ . . . v₀) in step 763. In the following, we assume that dₙ₋₁, the most significant bit of the secret key, is 1. The recoding module computes the new representation of the secret key digit by digit. More precisely, module 720 computes x with w bits extracted from d, whereas module 730 computes y with w−1 bits extracted from d, and both module are executed concurrently. Then, module 740 selects x or y depending on system parameters and on the selection data q. Finally, the chosen recoded digit is stored in RAM 103 in step 751, and the algorithm proceeds with the next digits of the secret key d.

Next, we describe the digit computation modules 720 and 730 in details. They are exactly the same, except that module 720 scan w bits from the secret key d, whereas module 730 scans only w−1 bits. In other words, starting from the i-th bit of d, the value (d_{i+w-1} . . . dᵢ)₂−c is assigned to x in step 721, where c is a carry initialized to zero in step 702, and the value (d_{i+w-2} . . . dᵢ)₂−c is assigned to y in step 731. In step 722 and 732, the CPU checks if x and y are negative or zero. If x is negative or zero, 2^{w} is added to x by the CPU 114, and the temporary carry cₓ is set to 1 in step 723. If not, the value zero is assigned to the temporary carry cₓ in step 724: the constant 1 is moved to the RAM area corresponding to cₓ. If y is negative or zero, 2^{w-1} is added to y by the CPU 114, and the temporary carry c_{y} is set to 1 in step 733. If not, the value zero is assigned to c_{y} in step 734.

The digit selection module 740 proceeds as follows. The CPU checks if x is smaller than 2^{w-1} in step 741. If this is the case, then x is chosen as recoded digit with probability k/2^{w-1}−1, and y is chosen with probability 2−k/2^{w-1}. More specifically, w bits are extracted by the CPU 114 from the selection data q in step 742 by computing Q=q mod 2^{w-1}, and q is updated with q−Q/2^{w-1}, that is, the CPU performs a right (w−1)-bit shift on the selection data q. If Q is greater than k−2^{w-1}, x is selected in step 746, otherwise y is selected in step 744. Since Q consists of w−1 random bits, Q can take 2^{w-1} different values and the probability that Q is greater than k−2^{w-1} and therefore that x is selected is indeed k/2^{w-1}−1. Now, in the case where x>2^{w-1}, there are two possibilities: either the entry B[x] of the upper half of the index table is zero, or it is non zero. If it is non-zero, x is selected in step 746, and if it is zero, y is selected in step 744. Step 744 assigns y to the recoded digit u by moving the value of y in RAM to the RAM area corresponding to u, assigns the value of temporary carry c_{y} to the carry c for the next iteration, and sets the selected width r to w−1. Similarly, step 746 assigns x to u, cₓ to c and w to r.

Now that the digit u, the next carry c and the width r have been selected by module 740, step 703 saves the value of the digit u as the i-th recoded digit vi, and puts 0 in the (r−1) next digits vᵢ₊₁, vᵢ₊₂ until vᵢ₊ᵣ₋₁ in step 751. Finally, the procedure is iterated from step 711, and the next bits of the secret key d are scanned starting from bit i+r. When all bits have been scanned up to the bit n−w, the recoding outputs the last digits in steps 761 and 762. Since dₙ₋₁=1, the last carry is always neutralized and the algorithm terminates correctly with a positive or null digit. Finally, the recoding algorithm outputs the recoded secret key (vₙ₋₁ . . . v₀) in step 761 and stores it in RAM 103 for future use.

The scope of our patent is not limited to a particular recoding algorithm. For example, in alternative embodiments, more than two recoded digits x and y could be computed concurrently, and the selection data p could still determine which of the recoded digits is selected.

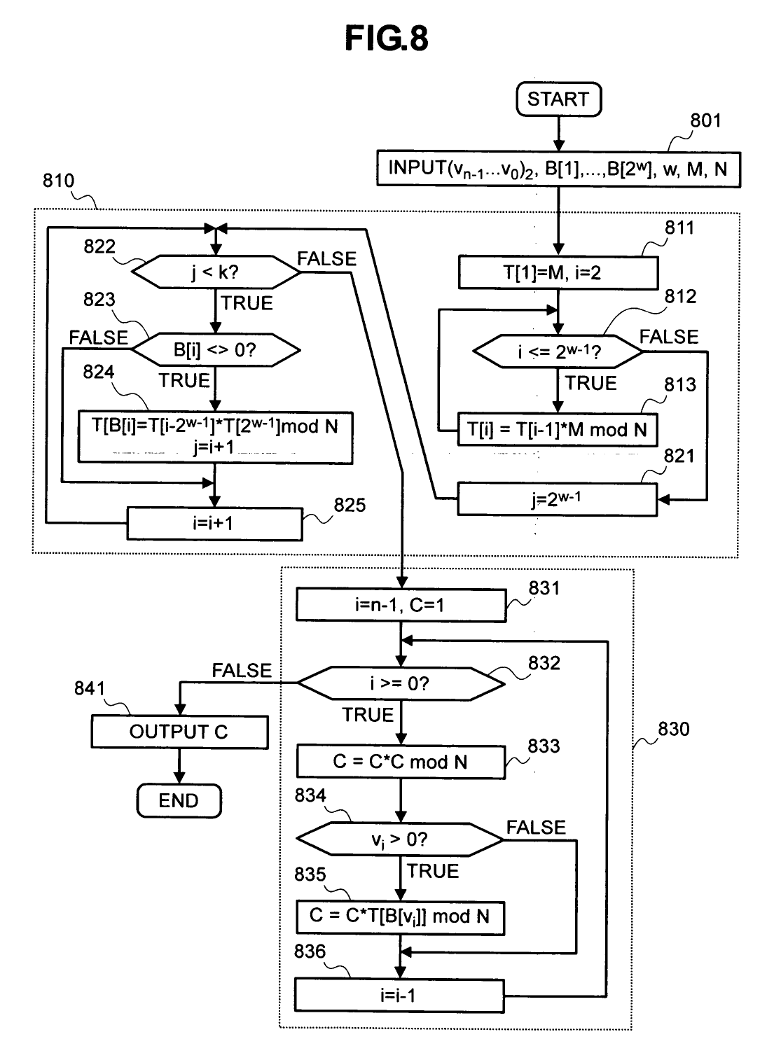

### *Message Encryption Module, FIG. 8*

The message encryption module 205 takes the recoded secret key (vₙ₋₁ . . . v₀) 241, the system parameters 231, the message M and the modulus N 212 as input, and computes the output message C 251. In fact, the output message is C=M^{d} mod N, that is, the exponentiation of message M with the secret key d as exponent, modulo the modulus N. However, instead of using the secret key d for the computations, the recoded secret key (vₙ₋₁ . . . v₀) 241 is utilized for calculating C. In our preferred embodiment, the message encryption module is implemented as a program stored in ROM 107 or EEPROM 106 and executed by the CPU, but in other possible embodiments of our invention, it could be hardwired as a dedicated computation unit. The message encryption module 205 contains two main modules: the pre-computation module 810, and the computation module 830.

The pre-computation module 810 assigns pre-computed values to entries of a table t[1], t[2], . . . , t[2^{w}]. In steps 811, 812 and 813, the lower half entries of the pre-computed table are evaluated and stored in RAM 103. In step 811, the value of the message is moved in the RAM area corresponding to the table entry t[1]. Next, t[2] is computed by the coprocessor 115 in step 813 as t[1]*M mod N, t[3] as t[2]*M mod N, and so on until t[2^{w-1}]. Note that in our embodiment, the coprocessor 115 is used to compute multiplications since they involve long operands and would take too much time if computed by the CPU 114.

In steps 821 through 825, the upper half entries of the pre-computed table are evaluated and stored in RAM 103. Since the table size is k, and already has 2^{w-1} entries in its lower half, only k−2^{w-1} entries are computed in this phase. More specifically, a new entry is calculated only in the case where its corresponding index entry B[i] is not zero: for some given index 2^{w-1}+1<=i<=k, the table entry t[B[i]] is calculated with the coprocessor as t[i−2^{w-1}]*t[2^{w-1}] mod N. Note that here again, the coprocessor 115 is used to accelerate the multiplication, which has long operands and would take too much time if computed by the CPU 114. When k entries have been computed in the table t[1], . . . , t[k], the computation module 830 is activated.

The computation module 830 uses the pre-computed table t[1], . . . , t[k], the index table B[1], . . . , B[2^{w}] and the recoded digits (vₙ₋₁ . . . v₀). The module scans the recoded digit from left to right, that is, starting with the index i=n−1 down to 0. An accumulator C is initialized with the constant 1, moved to the RAM area corresponding to C in step 831. At each iteration, the accumulator is squared in step 832, where the coprocessor 115 computes C*C mod N and stores the result in the RAM area corresponding to C. In addition, the CPU checks if the i-th recoded digit vᵢ is non-zero in step 834. If this is the case, the accumulator is multiplied with the pre-computed entry t[B[vᵢ]] in step 835, where the coprocessor 115 computes C*t[B[vᵢ]] mod N and stores the result in RAM 103.

This procedure is iterated until all recoded digits are scanned; after that, the accumulator is sent as output of the message encryption module in step 841.

### Embodiment 1

Consider for instance the RSA exponentiation M^{d} mod N with the secret exponent d=65=(1000001)₂ and table size k=3. First, the selection data (p,q) is computed with s=65 and t=0x98badcfe10325476c3d2e1f067452301efcdab89.

G(t,s)=0xf66a29cc54a9b116ee864c6f4db496d59279bb69=p

Therefore, the seed becomes:

s=s+p+1 mod 2¹⁶⁰=0xf66a29cc54a9b116ee864c6f4db496d59279bbab

After that, q is computed:

G(t,s)=0xd3020de628c235fb19d961513937233dba489915

and

q=(0010101)₂.

Next, system parameters are generated. Since k=3, the upper width w is w=CEIL(log₂(k))=2. Now, the index table can be prepared: B[1]=1, B[2]=2, B[3]=0, B[4]=0. In the upper half index table, one index will be randomly chosen between 3 and 4 according to p: since p mod 2=1, we set B[4]=3. In other words, the pre-computed table in the message encryption stage will consist of m¹, m² and m⁴. After that, the secret exponent d=65 is recoded.

First Step (i=0):

x=(d₁d₀)₂=1 and y=(d₀)₂=1. Because x<=2, both recodings are possible. Therefore, we use the selection bit q₀=1, and select y: v₀y=1.

Second Step (i=1):

x=(d₂d₁)₂=0 and y=(d₂)₂=0; but zero values are forbidden and we add 4 to x, and keep a carry cₓ=1 for the next digit. Similarly, we add 2 to y and keep a carry c_{y}=1. Thus, x=4 and y=2. Since 4 was chosen as non-zero index in the index table (B[4]=3<>0), x is chosen as recoded digit. Therefore, v₁=4, v₂=0 and c=cₓ=1.

Third Step (i=3):

x=(d₄d₃)₂−c=−1 and y=(d₃)₂−c=−1; but negative values are forbidden and we add 4 to x, and keep a carry cₓ=1 for the next digit. Similarly, we add 2 to y and keep a carry c_{y}=1. Thus, x=3 and y=1. Since B[3]=0, y is chosen as recoded digit. Therefore, v₃=1, and c=c_{y}=1.

Fourth Digit (i=4):

x=(d₅d₄)₂−c=−1 and y=(d₄)₂−c=−1; but negative values are forbidden and we add 4 to x, and keep a carry cₓ=1 for the next digit. Similarly, we add 2 to y and keep a carry c_{y}=1. Once again, x=3 and y=1. Since B[3]=0, y is chosen as recoded digit. Therefore, v₄=1, and c=c_{y}=1.

Fifth Step (i=5):

x=(d₆d₅)₂−c=1 and cₓ=0. Also, y=(d₄)₂−c=−1. Since y is negative, y=y+2=1 and we keep a carry c_{y}=1. Since x<=2, both patterns are acceptable. We use q₁ to take our decision: since q₁=0, we choose the recoding x. Therefore, v₅=1, v₆=0 and c=cₓ=0.

We get as final recoding: d=65=(1000001)₂=(0111041)ₖ₌₃. After that, the pre-computed table is prepared. T[1]=M, and T[2]=t[1]*M=M² mod N. The last entry of the pre-computed table is T[B[4]]=t[3]=T[2]*T[2]=M⁴ mod N. Finally, the exponentiation is computed.

C=1 Step i=5

C=C*T[B[v₅]]=1*T[1]=M mod N Step i=5

C=C²*T[B[v₄]]=M²*T[1]=M³ mod N Step i=4

C=C²*T[B[v₃]]=M⁶*T[1]=M⁷ mod N Step i=3

C=C²=M¹⁴ mod N Step i=2

C=C²*T[B[v₁]]=M²⁸*T[3]=M³² mod N Step i=1

C=C²*T[B[v₀]]=M⁶⁴*T[1]=M⁶⁵,output C=M⁶⁵ mod N. Step i=0

### *Extensions*

The scope of this patent is not limited to the latter embodiment, which can be easily modified in order to combine the selection data generation step, the recoding step and the encryption step, achieving on-the-fly computations. Although the recoding step is performed from right to left, the scope of the patent is not limited to that example: the recoding can be performed with a different strategy, different terminal cases, and more generally, any recoding based on the randomization of the representation of the secret value. With small modifications, the latter embodiment can also be used in other cryptographic protocols, such as Diffie-Hellman key exchange, ElGamal encryption or DSA. In addition, the selection data generation module is only one implementation possibility of our invention. Other possibilities are, but not limited to: using a different random number generator with the secret data as seed, using a different hash function, using a block cipher, computing and storing the selection data once for all. Finally, in the embodiment presented above, the recoding algorithm chooses one recoded digit between two possibilities x and y, but the scope of our patent is not limited to this case. The recoding algorithm could select one recoded digit among an arbitrary number of possible choices, and not just two.

### Embodiment 2

### Secure Multiple Use of a Secret Key for ECC

In the first embodiment of our invention, RSA exponentiations could be securely computed with the same secret key, thanks to selection data generated with a random number generator. In the second embodiment, we show how to securely compute elliptic curve operations using selection data generated with a hash function.

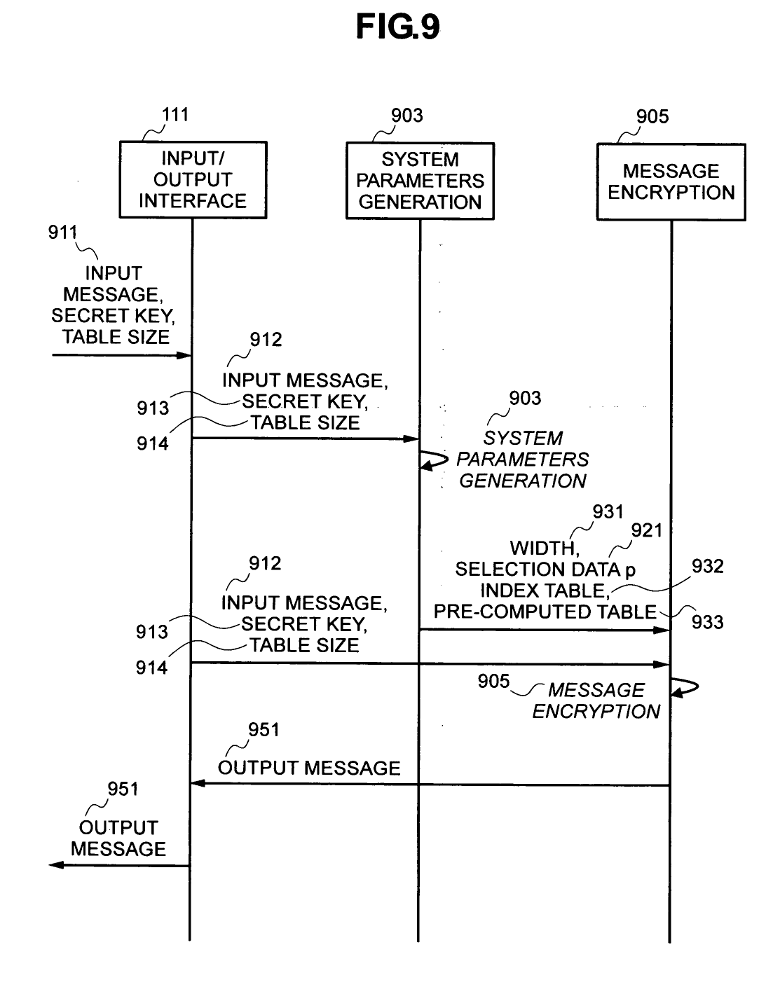

### *Time Diagram and Data Flow, FIG. 9*

In the second embodiment, the selection data is computed on-the-fly in the system parameters generation step and the message encryption step. In addition, the pre-computed table is calculated in the system parameters generation step, in the same time as the index table, and the recoding step is embedded in the message encryption step. In short, some steps are merged in order to avoid storage of temporary data between the different stages.

The first step is the system parameters generation 903, which calculate the upper width w, the index table B[1], . . . , B[2^{w-1}] and the pre-computed table T[1], . . . , T[k] from the secret key 913 and the table size 914. The selection data p which is necessary for the index table is generated on-the-fly in this stage.

The second and final step is the message encryption 905. The message encryption step takes the selection data p 921, width 931, index table 932 and pre-computed table 933 as input, and calculates the output message 951. The recoding of the secret data is interleaved with the message encryption, and the selection data q is calculated on the fly in step 905.

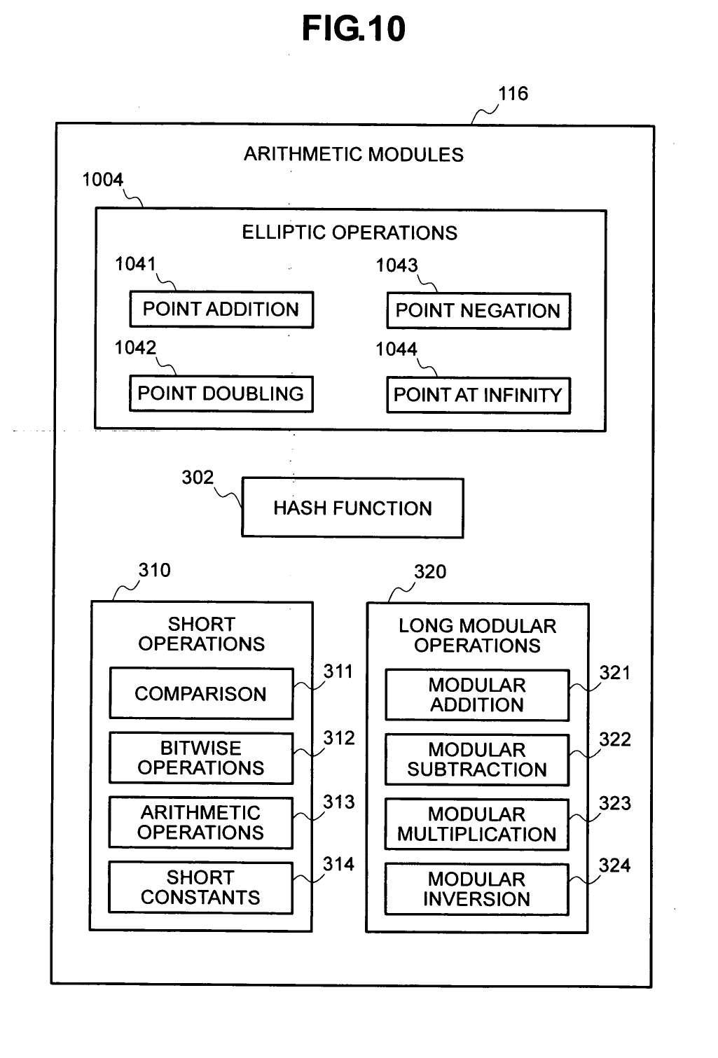

### *Arithmetic Modules, FIG. 10*

In our second embodiment, the arithmetic modules are similar to that of the first embodiment: short operation modules 310 are supported by the instruction set of the CPU 114, whereas long modular operation modules can benefit from the coprocessor 115, at least for the modular multiplication module 323. The hash function module SHA-1 302 is also available. In addition to that, our second embodiment has elliptic operation modules.

Elliptic operation modules 1004 include three types of operations, point addition 1041, doubling 1042 and negation 1043, and one special constant value, the point at infinity 1044. Such elliptic operations manipulate elliptic points, which include two n-bit coordinates P=(x,y). The bitlength n is typically 160 or 256 bits, and elliptic operations can benefit from coprocessor support for computing modular multiplications. In our embodiment, the elliptic operation modules 1004 are directly supported by the coprocessor 115, but in alternative embodiments, they could be implemented as programs stored in ROM 107 and executed by the CPU 114, possibly with coprocessor support for modular multiplications, or any other equivalent method.

In our second embodiment, the elliptic point addition ECADD 1031 is supported by coprocessor 115, which executes the following sequence of operations:
Given P=(x1,y1), Q=(x2,y2) and a modulus m
   1. compute k=(y2−y1)*(x2−x1)⁻¹ mod m
   2. compute x3=k*k−x1−x2 mod m
   3. compute y3=k*(x1−x3)−y1 mod m
   4. return R=ECADD(P,Q)=(x3,y3)

Note that ECADD makes use of modular multiplications 323 executed by the coprocessor 115 in steps 1, 2 and 3, a modular inversion 324 in step 1 and modular additions 321 and subtraction 322 in steps 2 and 3.

The elliptic point doubling ECDBL 1032 is supported by the coprocessor 115, which executes the following sequence of operations:
Given P=(x1,y1), curve parameter a and modulus m
   1. compute k=(3*x1*x1+a)*(2y1)⁻¹ mod m
   2. compute x3=k*k−2*x1 mod m
   3. compute y3=k*(x1−x3)−y1 mod m
   4. return R=ECDBL(P)=(x3,y3)

The modular multiplications 323 in steps 1, 2 and 3 are calculated by the coprocessor 115, as well as the modular additions and subtractions in steps 1, 2, 3, and the inversion 324 in step 1.

Point negation 1033 is a simple modular subtraction 322, computed by the coprocessor 115 as follows: given a point P=(x1,y1) and a modulus m, the negative point is −P=(x1,−y1 mod m). Finally, a constant called “point at infinity” inf 1034 is often needed for initializations. The point at infinity plays a similar role to that of zero in the case of integers: ECADD(P,inf)=ECADD(inf,P)=P and ECDBL(inf)=inf. For the sake of simplicity, the point of infinity can be stored in memory 102 as a point with zero coordinates: inf=(0,0).

Although elliptic operations are fully supported by the coprocessor 115 in our second embodiment, the scope of our patent is not limited to this case: alternatively, elliptic operations could be programs stored in ROM 107 and executed by the CPU 114, possibly with the help of the coprocessor 115 for some operations, modular multiplications for instance.

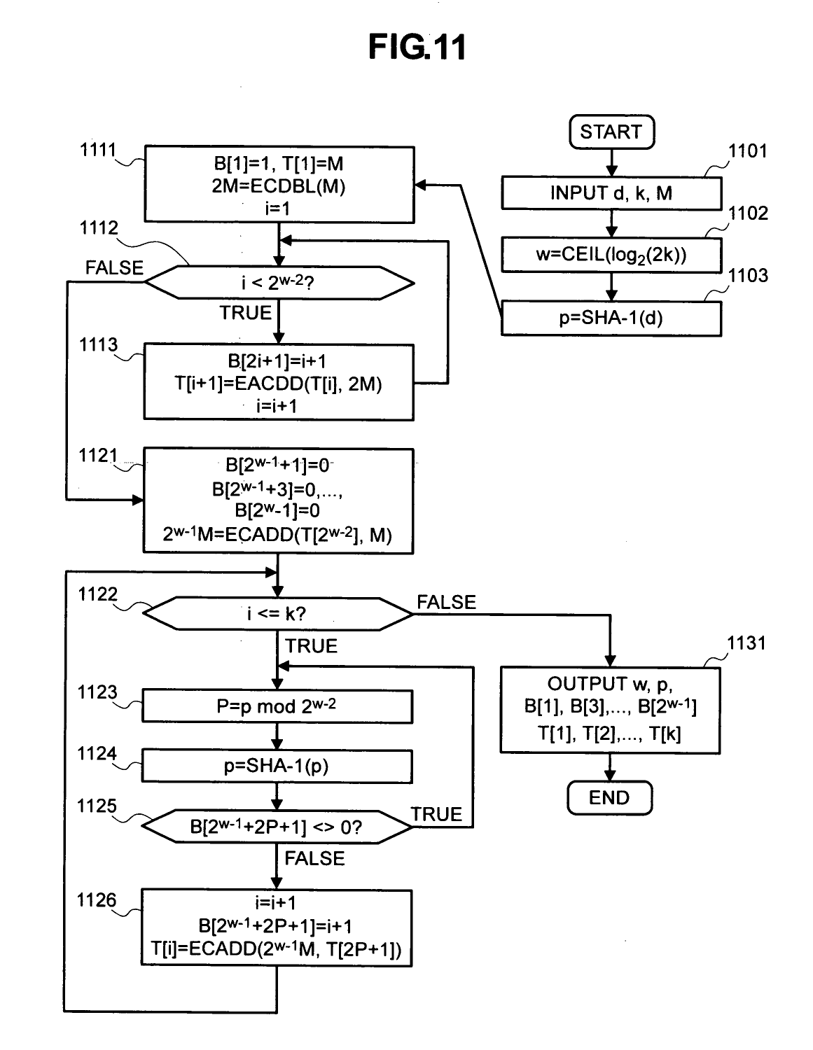

### *System Parameters Generation, FIG. 11*

The input of the system parameters generation step includes the input message M 912, the secret key d 913, and the table size k 914, and its output is the width w 931, the selection data p 921, the index table B[1], B[3], B[5], . . . , B[2^{w}−1] 932 and the pre-computed table T[1], . . . , T[k] 933.

In step 1102, the width w 931 is computed as CEIL(log₂(k)). In practice, w can be calculated by the CPU 114 from a program stored in ROM 107, or simply assigned from memory thanks to a lookup table stored in EEPROM 106 or ROM 107. After that, the selection data p is computed as SHA-1(d) in step 1103, where SHA-1 is the standard one-way hash function described in non-patent literature 1.

In steps 1111 through 1113, the lower half index table B[1], B[3], B[5], . . . , B[2^{w-1}−1] and pre-computed table T[1], . . . , T[2^{w-2}] are computed and stored in RAM 103. More precisely, B[1]=1, B[3]=2, B[5]=3, B[7]=4 and so on up to B[2^{w-1}−1]=2^{w-2}, and T[1]=M, T[2]=3M, T[3]=5M, T[4]=7M, and so on up to T[2^{w-2}]=(2^{w-1}−1)*M. Note that 2M=ECDBL(M) is calculated in step 1111 and stored in RAM 103, and thus, T[i+1]=(2i+1)*M=ECADD(T[i−1],2M)=(2i+1)*M+2M can be calculated correctly in step 1113. Here, the procedures ECDBL and ECADD refer to elliptic point doubling and elliptic point addition, respectively.

Next, the upper half index table B[2^{w-1}+1], . . . , B[2^{w}−1] and pre-computed table T[2^{w-2}+1], . . . , T[k] are calculated in steps 1021 through 1026. In step 1121, the upper index table B[2^{w-1}+1], B[2w−1+3], . . . , B[2^{w}−1] is initialized with zeros, and the elliptic point 2^{w-1}M is computed as:

ECADD(T[2^{w-2}],M)=(2^{w-1}−1)*M+M,

and stored in RAM 103. With this initialization work done, the upper tables can be computed. First, an odd random index between 2^{w-1}+1 and 2^{w}−1 is chosen using the selection data p in step 1123. More precisely, the random index is be 2^{w-1}+2P+1 using P=p mod 2^{w-2}, and p is updated with p=SHA-1(d), using the standard one-way hash function SHA-1. If the index entry B[2^{w-1}+2P+1] is non-zero, that is, the entry was already selected, a new value for P in step 1123 and p is updated again with p=SHA-1(p). Note that the operation of computing P=p mod 2^{w-2} consists of extracting the w−2 least significant bits of p with the CPU 114, and SHA-1(p) is easily computed by the CPU 114, or possibly the coprocessor 115. Eventually, a value P such that B[2^{w-1}+2P+1]=0 is found, and the index i is incremented by 1, the index entry B[2^{w-1}+2P+1] is set to i by moving the value of i stored in RAM 103 to the RAM area corresponding to the index table, and the pre-computed entry T[i] is computed as:

ECADD(2^{w-1}M,T[2P+1])=2^{w-1}M+(2P+1)*M.

Note that 2^{w-1}M has been computed in step 1021, and T[2P+1] is also available from the lower pre-computed table, therefore, both values are present in RAM 103, and can be processed by the CPU 114 and the coprocessor 115. Steps 1122 through 1126 are iterated until exactly k pre-computed entries have been calculated. Finally, the width w 931, selection data p 921, index table B[1], B[3], B[5], . . . , B[2^{w}−1] 932, pre-computed table T[1], T[2], . . . , T[k] 933 are stored in RAM 103 for future use.

The scope of our patent is not limited to the use or implementation of a particular one-way function; in alternative embodiments, a different hash function such as RIPEMD-160 or a block cipher such as DES, triple DES or AES could be used. In addition, the scope of our patent is not limited to a particular method for computed the random indices of the index table B. For instance, in step 1123, the selection data p could be updated in a different manner, as p=p/2^{w-1} for instance.

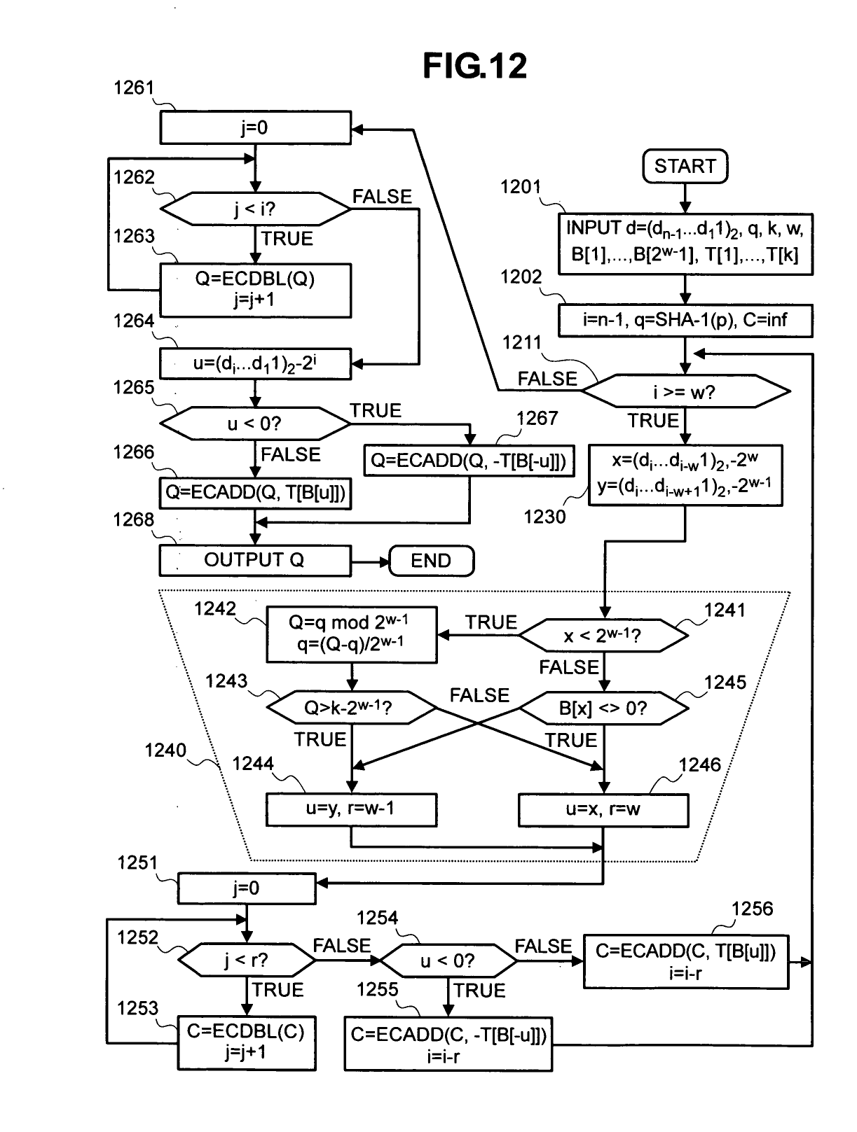

### *Message Encryption, FIG. 12*

From the secret key d=(dₙ₋₁ . . . d₁1)₂ 913, the selection data p 921, the width w 931, the index table B[1], B[3], . . . , B[2^{w}−1] 932, the pre-computed T[1], T[2], . . . , T[k] 933 and the message M 912, the message encryption module calculates C=d*M=M+M+ . . . +M, with d elliptic additions. In addition, the operation d*M is calculated in a secure manner thanks to a randomized recoding of d performed on the fly during calculations. Note that it is assumed that d is odd; if this is not the case, d can always been set to d+1, and becomes odd.

In step 1202, the bit counter i is initialized with n−1 and the selection data q with SHA-1(p). In addition, the accumulator C, an elliptic point C=(X,Y), where X and Y are n-bit strings, is initialized with the value inf, point at infinity. The point at infinity plays a similar role for elliptic points to that of zero for integers and addition. For any elliptic point M, ECADD(inf,M)=M, and in addition ECDBL(inf)=inf. In step 1230, the two recoded digits x and y are computed concurrently as:

x=(dᵢ . . . d_{i-w+1}1)₂−2^{w}

and

y=(dᵢ . . . d_{i-w+2}1)₂−2^{w-1}.

Thus, x and y are odd, −2^{w}<x<2^{w} and −2^{w-1}<y<2^{w-1}.

In module 1240, the recoded digit u is chosen between x and y, according to the value of x, the index table and the selection data q. More specifically, if x<2^{w-1}, x is selected with probability k/2^{w-2}−1 and y with probability 2−k/2^{w-2}. This random choice is done thanks to the selection data q: the w−2 least significant bits of q are extracted in Q=q mod 2^{w-2} in step 1242, and q is updated with q=(q−Q)/2^{w-2}, that is, a (w−2)-bit right shift. Then, Q is compared to k−2^{w-2}; if Q>k−2^{w-2}, y and w−1 are selected as recoded digit and width in step 1244, otherwise x and are selected in step 1246. If x>2^{w-1}, there are two possibilities: either B[x]<>0, meaning that x was selected as index entry in the system parameters generation module 903, or B[x]=0. If B[x]=0, y and w−1 are selected, otherwise x and w are selected.

In steps 1251 through 1254, elliptic operations are computed. Steps 1252 and 1253 are iterated to compute r elliptic point doublings ECDBL, where r can be either w−1 or w according to the selection step 1240. Thus, when all iterations have been performed, the value of the accumulator C becomes 2^{r}C. After that, an elliptic point addition ECADD is computed: if u is positive, the pre-computed entry T[B[u]] is added to the accumulator C in step 1256, and if u is negative, −T[B[−u]] is added to C in step 1255. In both cases, the bit index i is decreased by r. Note that if T[B[−u]]=(x,y), then −T[B[−u]]=(x, −y).

This procedure is iterated until the bit index i becomes smaller than w. When this happens, the last i+1 bits are processed, from dᵢ down to d₀=1. In steps 1261, 1262 and 1263, elliptic point doublings are applied i times on the accumulator, which is updated with 2ⁱC. The last non-zero digit, namely u=(dᵢ . . . d₁1)₂−2ⁱ is computed in step 1264. If u<0, the pre-computed entry −T[B[−u]] is added to the accumulator C in step 1267; otherwise, T[B[u]] is added to Q in step 1266. Finally, the accumulator C is transmitted as output of the module and result of the cryptographic operation C=dM in step 1268.

### *Extensions*

The scope of this patent is not limited to the latter embodiment, which can be easily modified in order to match the first embodiment, that is, with selection data and recoding performed separately and not on the fly. Although the recoding step is performed from left to right in order to allow on the fly computations, the scope of the patent is not limited to that example: the recoding can be performed with a different strategy, different terminal cases, and more generally, any recoding based on the randomization of the representation of the secret value. With small modifications, the latter embodiment can also be used in other cryptographic protocols, such as elliptic curve Diffie-Hellman key exchange, elliptic curve ElGamal encryption or ECDSA. In addition, the selection data generation modules are only one implementation possibility of our invention. Other possibilities are, but not limited to: using a random number generator with the secret data as seed, using a different hash function, using a block cipher, computing and storing the selection data once for all. Finally, in the embodiment presented above, the recoding algorithm chooses one recoded digit between two possibilities, but the scope of our patent is not limited to this case. The recoding algorithm could select one recoded digit among z possible choices for arbitrary z.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A cryptographic processing system for securely performing a cryptographic processing operation, comprising:
(a) a first module which is configured to receive an input message to be cryptographically processed;
(b) a memory which is configured to store a secret key and a selection data;
(c) a recoding module which is configured to produce a recoded key, the module including:
(c-1) at least two predetermined transformation modules which will process the secret key and produce at least two recodings thereof, and
(c-2) a selection module which will select a recoded key among the recodings according to the selection data; and
(d) a second module which is configured to encrypt the input message according to the recoded key, wherein
the pair of the secret key and the selection data is uniquely determined.

2. The cryptographic processing system of claim 1 further comprising a selection data generation module processing the secret key and producing the selection data, wherein the selection data is uniquely determined by the secret key.

3. The cryptographic processing system of claim 2, wherein the selection data generation module comprises a random number generator which will use the secret key as a seed and process the seed to produce a random number, whereby the selection data is the random number.

4. The cryptographic processing system of claim 2, wherein the selection data generation module is a hash function.

5. The cryptographic processing system of claim 4, wherein the hash function is SHA-1.

6. The cryptographic processing system of claim 2 wherein the selection data generation module is a block cipher.

7. The cryptographic processing system of claim 1, wherein the recoding module further comprises:
(c-3) a bit extraction module which is configured to extract at least one bit of the secret key,
(c-4) at least two predetermined transformation modules, each of which is configured to process the extracted bits and produce at least two digit candidates,
(c-5) a selection module which is configured to select a recoded digit among the digit candidates according to the selection data, and
(c-6) a control module which is configured to activate the bit extraction, predetermined transformation and selection modules in an iterative manner, until all bits of the secret key have been extracted, whereby
the recoded secret key will comprise a plurality of the recoded digits generated by the recoding module.

8. A digital signature generation system in a computer system for generating a digital signature of an input message, comprising:
(a) a cryptographic processing system according to claim 1 which will encrypt the input message according to a secret key, and the digital signature is the output message of the cryptographic processing system, and
(b) third means for sending the input message and the digital signature to a second computer system.

9. A decryption system in a computer system for decrypting an input message encrypted by a second computer system, comprising a cryptographic processing system according to claim 1, wherein the cryptographic processing system encrypts the input message according to a secret key, and the decrypted message is the output message of the cryptographic processing system.

10. A key exchange system in a computer system for exchanging a session key with a second computer system, comprising:
(a) a cryptographic processing system according to claim 1 which will encrypt an input message received from the second computer according to a secret key, and the session key is the output message of the cryptographic processing system;
(b) a third module which is configured to encrypt and decrypt data according to the session key; and
(c) fourth means for exchanging data encrypted with the session key with a second computer system, whereby
the computer system and the second computer system share the same session key.

11. A method of securely performing a cryptographic processing operation in a cryptographic processing system, comprising the following steps of:
(a) receiving an input message;
(b) providing a memory storing a secret key and a selection data;
(c) recoding the secret key, wherein the recoding step includes the followings:
(c-1) the recoding step will process the secret key, thereby producing at least two recodings thereof, and
(c-2) the recoding step will select a recoded key among the recodings according to the selection data; and
(d) providing an encryption means which will encrypt the input message according to the recoded key, wherein
the pair of the secret key and the selection data is uniquely determined.

12. The method of claim 11 further comprising the step of generating a selection data from the secret key, wherein the selection data is uniquely determined by the secret key.

13. The method of claim 12, wherein the step of generating the selection data further comprises:
(1) using the secret key as a seed of a random number generation method, and
(2) producing a random number with the random number generation method, whereby
the selection data is the random number.

14. The method of claim 12, wherein the step of generating the selection data comprises hashing the secret key with a hash function.

15. The method of claim 14, wherein the hash function is SHA-1.

16. The method of claim 12, wherein the step of generating the selection data comprises processing the secret key with a block cipher.

17. The method of claim 11, wherein the step of recoding the secret key further comprises the following steps of:
(c-3) extracting at least one bit of the secret key;
(c-4) processing the extracted bits with at least two predetermined transformations which will produce at least two digit candidates;
(c-5) selecting a recoded digit among the digit candidates according to the selection data; and
(c-6) repeating the above steps (c-3) to (c-5) in an iterative manner as many times as required until all bits of the secret key have been extracted, whereby
the recoded secret key will comprise a plurality of the recoded digits generated by the recoding module.

18. A method for generating a digital signature of an input message in a computer system, comprising the following steps of:
(a) processing the input message according to the method of claim 11, wherein the digital signature is the output message produced by the input message processing step; and
(b) sending the input message and the digital signature to a second computer system.

19. A method of decrypting an input message in a computer system encrypted by a second computer system, comprising the step of processing the input message according to the method of claim 11, whereby the decrypted message is the output message produced by the input message processing step.

20. A method for exchanging a session key in a computer system for exchanging a session key with a second computer system, comprising the following steps of:
(a) processing an input message received from the second computer system according to the method of claim 11, and the session key is the output message of the cryptographic processing system;
(b) providing means for encrypting and decrypting data according to the session key; and
(c) exchanging data encrypted with the session key with a second computer system, whereby
the computer system and the second computer system share the same session key.
